(19) United States
(12) Patent Application Publication
(10) Pub. No.: US 2003/0225513 A1
(43) Pub. Date: Dec. 4, 2003

(54) Method and apparatus for providing multi-level blended display of arbitrary shaped textures in a geo-spatial context

(76) Inventors: Nikhil Gagvani, Princeton, NJ (US); John Crane Mollis, Titusville, NJ (US)

Correspondence Address: MOSER, PATTERSON & SHERIDAN, LLP, /SARNOFF CORPORATION, 595 SHREWSBURY AVENUE, SUITE 100, SHREWSBURY, NJ, 07702, US

(21) Appl. No.: 10/413,414

(22) Filed: Apr. 14, 2003

Related U.S. Application Data
(60) Provisional application No. 60/372,301, filed on Apr. 12, 2002.

(51) Int. Cl. G01C 21/32

(52) U.S. Cl. 701/211; 701/208; 340/995.14; 340/995.15

(57) ABSTRACT

Method and apparatus for displaying geo-spatial images. Specifically, the method displays a geo-spatial image by providing a textured region of interest; selecting an arbitrary shaped area within the textured region of interest; and overlaying an image over the arbitrary shaped area.

This non-provisional application claims the benefit of U.S. provisional application serial No. 60/372,301 filed Apr. 12, 2002, which is hereby incorporated herein by reference.

This invention was made with U.S. government support under contract number NMA202-97-D-1033 D0#33 of NIMA. The U.S. government has certain rights in this invention.

The invention is generally related to image processing systems and, more specifically, to a method and apparatus for performing geo-spatial registration and visualization within an image processing system.

### BACKGROUND OF THE INVENTION

The ability to locate scenes and/or objects visible in a video/image frame with respect to their corresponding locations and coordinates in a reference coordinate system is important in visually-guided navigation, surveillance and monitoring systems.

Various digital geo-spatial products are currently available. Generally, these are produced as two dimensional maps or imagery at various resolutions. Current systems (e.g., MAPQUEST™) display these products as two-dimensional images which can be panned and zoomed at discrete levels of resolution (in several steps), but not continuously in a smooth manner. Additionally, the user is often limited to a rectangular viewing region.

Therefore, there is a need in the art for a method and apparatus that allows overlaying of multiple geo-spatial maps/images of arbitrary shapes within a region.

### SUMMARY OF THE INVENTION

The present invention is a method and apparatus for displaying geo-spatial images. The invention advantageously provides a method for displaying an arbitrary defined region and its respective geographical image. Specifically, the method displays a geo-spatial image by providing a textured region of interest; selecting an arbitrary shaped area within the textured region of interest; and overlaying an image over the selected arbitrary shaped area.

Furthermore, the invention does not limit the arbitrary defined region to be a rectangular shape. Arbitrary shaped regions can be visualized simultaneously and at resolutions different from each other.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a block diagram of an embodiment of a system incorporating the present invention;

FIG. 2 depicts a functional block diagram of an embodiment of a geo-registration system for use with the invention;

FIG. 3 depicts a flowchart of a method for displaying arbitrary shaped regions in accordance with the present invention;

FIG. 4 depicts a flowchart of a method for displaying arbitrary shaped regions in accordance with the present invention;

FIGS. 5-6 depict respective images used to create an embodiment of a textured geographical reference image;

FIG. 7 depicts an embodiment of a textured geographical reference image created from respective images depicted in FIGS. 5-6;

FIG. 8 depicts an embodiment of a textured geographical reference image smaller in geographical size than the images depicted in FIGS. 5-7;

FIG. 9 depicts an embodiment of a textured geographical reference image smaller in geographical size than the reference image depicted in FIG. 8;

FIG. 10 depicts an outline of an arbitrary defined region; and

FIG. 11 depicts an image within the arbitrary defined region.

To facilitate understanding, identical reference numerals have been used, where possible, to designate identical elements that are common to the figures.

### DETAILED DESCRIPTION

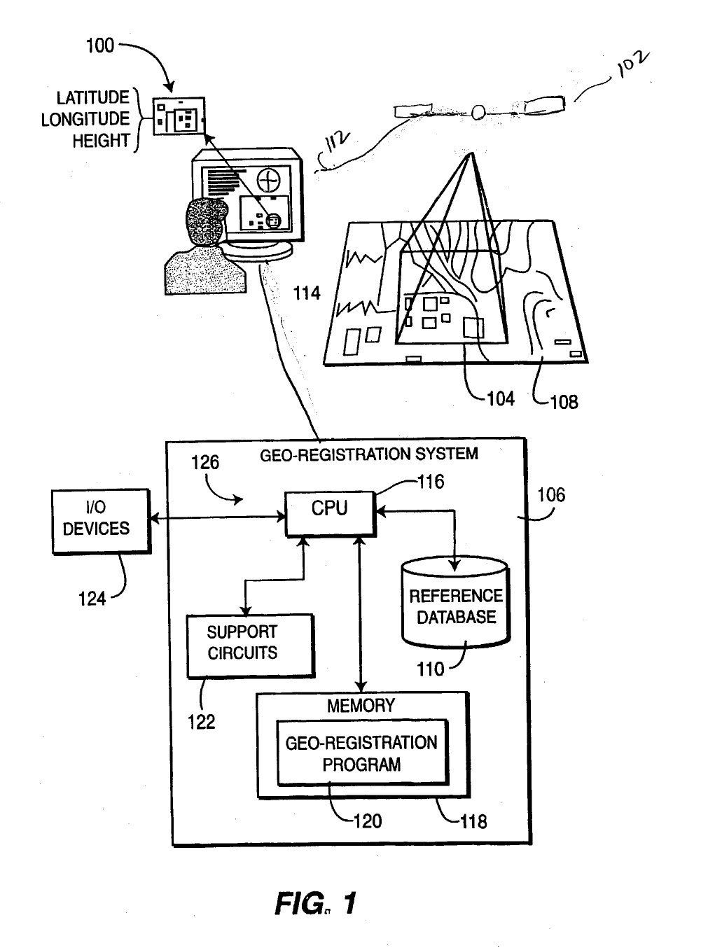

FIG. 1 depicts a block diagram of a comprehensive system 100 containing a geo-registration system 106 of the present invention. The figure shows a satellite 102 capturing images of a scene at a specific locale 104 within a large area 108. The system 106 identifies information in a reference database 110 that pertains to the current video images being transmitted along path 112 to the system 106. The system 106 “geo-registers” the satellite images to the reference information (e.g., maps) or imagery stored within the reference database 110, i.e., the satellite images are aligned with the map images and other information if necessary. After “geo-registration”, the footprints of the satellite images are shown on a display 114 to a user overlaid upon the reference imagery or other reference annotations. As such, reference information such as latitude/longitude/height of points of interest are retrieved from the database and are overlaid on the relevant points on the current video. Consequently, the user is provided with a comprehensive understanding of the scene that is being imaged.

The system 106 is generally implemented by executing one or more programs on a general purpose computer 126. The computer 126 contains a central processing unit (CPU) 116, a memory device 118, a variety of support circuits 122 and input/output devices 124. The CPU 116 can be any type of high speed processor. The support circuits 122 for the CPU 116 include conventional cache, power supplies, clock circuits, data registers, I/O interfaces and the like. The I/O devices 124 generally include a conventional keyboard, mouse, and printer. The memory device 118 can be random access memory (RAM), read-only memory (ROM), hard disk storage, floppy disk storage, compact disk storage, or any combination of these devices. The memory device 118 stores the program or programs (e.g., geo-registration program 120) that are executed to implement the geo-registration technique of the present invention. When the general purpose computer executes such a program, it becomes a special purpose computer, i.e., the computer becomes an integral portion of the geo-registration system 106. Although the invention has been disclosed as being implemented as an executable software program, those skilled in the art will understand that the invention may be implemented in hardware, software or a combination of both. Such implementations may include a number of processors independently executing various programs and dedicated hardware such as application specific integrated circuits (ASICs).

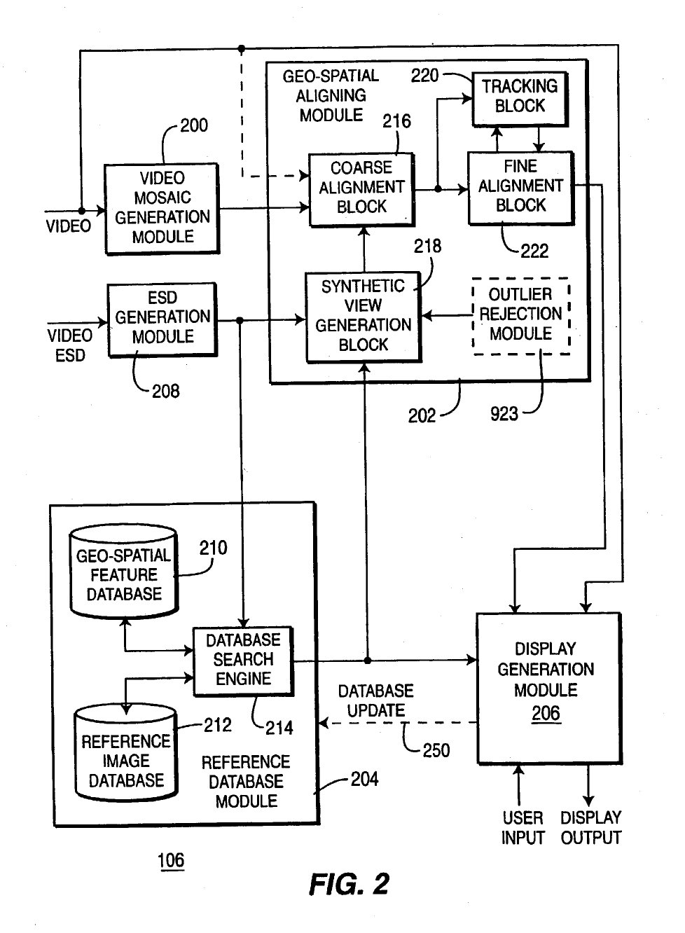

FIG. 2 depicts a functional block diagram of the geo-registration system 106 of the present invention. Illustratively, the system 106 is depicted as processing a video signal as an input image; however, from the following description those skilled in the art will realize that the input image (referred to herein as input imagery) can be any form or image including a sequence of video frames, a sequence of still images, a still image, a mosaic of images, a portion of an image mosaic, and the like. In short, any form of imagery can be used as an input signal to the system of the present invention.

The system 106 comprises a video mosaic generation module 200 (optional), a geo-spatial aligning module 202, a reference database module 204, and a display generation module 206. Although the video mosaic generation module 200 provides certain processing benefits that shall be described below, it is an optional module such that the input imagery may be applied directly to the geo-spatial aligning module 202. When used, the video mosaic generation module 200 processes the input imagery by aligning the respective images of the video sequence with one another to form a video mosaic. The aligned images are merged into a mosaic. A system for automatically producing a mosaic from a video sequence is disclosed in U.S. Pat. No. 5,649,032, issued Jul. 15, 1997, and incorporated herein by reference.

The reference database module 204 provides geographically calibrated reference imagery and information that is relevant to the input imagery. The satellite 102 provides certain attitude information that is processed by the engineering sense data (ESD) module 208 to provide indexing information that is used to recall reference images (or portions of reference images) from the reference database module 204. A portion of the reference image that is nearest the video view (i.e., has a similar point-of-view of a scene) is recalled from the database and is coupled to the geo-spatial aligning module 202. The module 202 first warps the reference image to form a synthetic image having a point-of-view that is similar to the current video view, then the module 202 accurately aligns the reference information with the respective satellite image. The alignment process is accomplished in a coarse-to-fine manner as described in detail below. The transformation parameters that align the video and reference images are provided to the display module 206. Using these transformation parameters, the original video can be accurately overlaid on a map.

In one embodiment, image information from a sensor platform (not shown) provides engineering sense data (ESD), e.g., global positioning system (GPS) information, INS, image scale, attitude, rotation, and the like, that is extracted from the signal received from the platform and provided to the geo-spatial aligning module 202 as well as the database module 204. Specifically, the ESD information is generated by the ESD generation module 208. The ESD is used as an initial scene identifier and sensor point-of-view indicator. As such, the ESD is coupled to the reference database module 204 and used to recall database information that is relevant to the current sensor video imagery. Moreover, the ESD can be used to maintain coarse alignment between subsequent video frames over regions of the scene where there is little or no image texture that can be used to accurately align the mosaic with the reference image.

More specifically, the ESD that is supplied from the sensor platform along with the video is generally encoded and requires decoding to produce useful information for the geo-spatial aligning module 202 and the reference database module 204. Using the ESD generation module 208, the ESD is extracted or otherwise decoded from the signal produced by the camera platform to define a camera model (position and attitude) with respect to the reference database. Of course, this does not mean that the camera platform and system can not be collocated, i.e., as in a hand held system with a built in sensor, but means merely that the position and attitude information of the current view of the camera is necessary.

Given that ESD, on its own, can not be reliably utilized to associate objects seen in videos (i.e., sensor imagery) to their corresponding geo-locations, the present invention utilizes the precision in localization afforded by the alignment of the rich visual attributes typically available in video imagery to achieve exceptional alignment rather than use ESD alone. For example, in aerial surveillance scenarios, often a reference image database in geo-coordinates along with the associated DEM maps and annotations is readily available. Using the camera model, reference imagery is recalled from the reference image database. Specifically, given the camera's general position and attitude, the database interface recalls imagery (one or more reference images or portions of reference images) from the reference database that pertains to that particular view of the scene. Since the reference images generally are not taken from the exact same perspective as the current camera perspective, the camera model is used to apply a perspective transformation (i.e., the reference images are warped) to create a set of synthetic reference images from the perspective of the camera.

The reference database module 204 contains a geo-spatial feature database 210, a reference image database 212, and a database search engine 214. The geo-spatial feature database 210 generally contains feature and annotation information regarding various features of the images within the image database 212. The image database 212 contains images (which may include mosaics) of a scene. The two databases are coupled to one another through the database search engine 214 such that features contained in the images of the image database 212 have corresponding annotations in the feature database 210. Since the relationship between the annotation/feature information and the reference images is known, the annotation/feature information can be aligned with the video images using the same parametric transformation that is derived to align the reference images to the video mosaic.

The database search engine 214 uses the ESD to select a reference image or a portion of a reference image in the reference image database 204 that most closely approximates the scene contained in the video. If multiple reference images of that scene are contained in the reference image database 212, the engine 214 will select the reference image having a viewpoint that most closely approximates the viewpoint of the camera producing the current video. The selected reference image is coupled to the geo-spatial aligning module 202.

The geo-spatial aligning module 202 contains a coarse alignment block 216, a synthetic view generation block 218, a tracking block 220 and a fine alignment block 222. The synthetic view generation block 218 uses the ESD to warp a reference image to approximate the viewpoint of the camera generating the current video that forms the video mosaic. These synthetic images form an initial hypothesis for the geo-location of interest that is depicted in the current video data. The initial hypothesis is typically a section of the reference imagery warped and transformed so that it approximates the visual appearance of the relevant locale from the viewpoint specified by the ESD.

The alignment process for aligning the synthetic view of the reference image with the input imagery (e.g., the video mosaic produced by the video mosaic generation module 200, the video frames themselves that are alternatively coupled from the input to the geo-spatial aligning module 202 or some other source of input imagery) is accomplished using two steps. A first step, performed in the coarse alignment block 216, coarsely indexes the video mosaic and the synthetic reference image to an accuracy of a few pixels. A second step, performed by the fine alignment block 222, accomplishes fine alignment to accurately register the synthetic reference image and video mosaic with a sub-pixel alignment accuracy without performing any camera calibration. The fine alignment block 222 achieves a sub-pixel alignment between the images. The output of the geo-spatial alignment module 202 is a parametric transformation that defines the relative positions of the reference information and the video mosaic. This parametric transformation is then used to align the reference information with the video such that the annotation/features information from the feature database 210 are overlaid upon the video or the video can be overlaid upon the reference images or both. In essence, accurate localization of the camera position with respect to the geo-spatial coordinate system is accomplished using the video content.

Finally, the tracking block 220 updates the current estimate of sensor attitude and position based upon results of matching the sensor image to the reference information. As such, the sensor model is updated to accurately position the sensor in the coordinate system of the reference information. This updated information is used to generate new reference images to support matching based upon new estimates of sensor position and attitude and the whole process is iterated to achieve exceptional alignment accuracy. Consequently, once initial alignment is achieved and tracking commenced, the geo-spatial alignment module may not be used to compute the parametric transform for every new frame of video information. For example, fully computing the parametric transform may only be required every thirty frames (i.e., once per second). Once tracking is achieved, the indexing block 216 and/or the fine alignment block 222 could be bypassed for a number of video frames. The alignment parameters can generally be estimated using frame-to-frame motion such that the alignment parameters need only be computed infrequently. A method and apparatus for performing geo-spatial registration is disclosed in commonly assigned U.S. Pat. No. 6,512,857 B1, issued Jan. 28, 2003, and is incorporated herein by reference.

Once the images are stored and correlated with geodetic position coordinates, the coordinated images can now be used in accordance with the methods as disclosed below. Specifically, these images are used for overlaying of geo-spatial maps/images of arbitrary shapes within a region of interest.

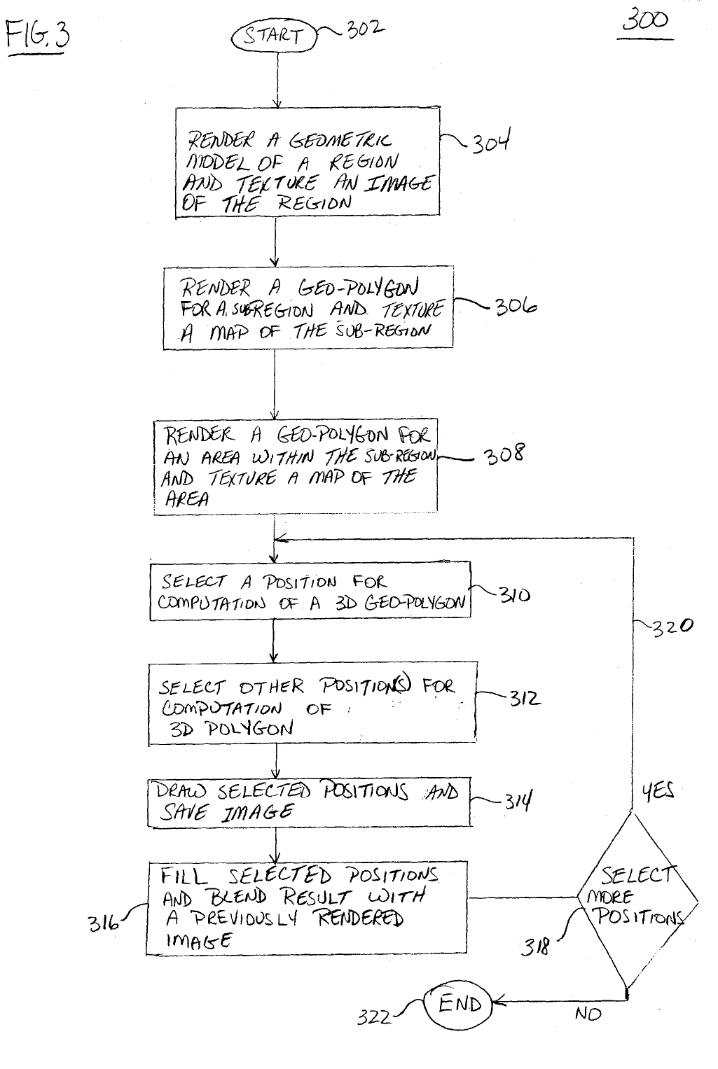

Specifically, FIG. 3 depicts a method 300 for overlaying geo-spatial maps/images of arbitrary shapes within a geographical region. To better understand the invention, the reader is encouraged to collectively refer to FIGS. 3, and 5-11 as method 300 is described below.

The method 300 begins at step 302 and proceeds to step 304. At step 304, the method 300 renders a geometric model of a geographical region. For example, FIG. 5 illustratively depicts this geometric model as a model of the earth 500 and is also referred to hereinafter as “G1”. The geographic rendition 500 comprises latitudinal lines 502 and longitudinal lines 504. Lines 502 and 504 form a grid over the entire geographic rendition 500.

In addition, a texture corresponding to the image of the area rendered by the geometric model (e.g., an image of the earth as viewed from space) is obtained. For example, FIG. 6 depicts a texture that is an image of the earth 600 (also referred to hereinafter as “T1”). A texture in computer graphics consists of texels (texture elements) which represent the smallest graphical elements in two-dimensional (2-D) texture mapping to “wallpaper” a three-dimensional (3-D) object to create the impression of a textured surface.

At step 304, the texture 600 is mapped to the geometric model 500. The end result is a textured rendition of the earth 700 which shows the topology of the earth as depicted in FIG. 7. The textured rendition 700 serves as a starting point and is an initial background layer of the present invention. The initial background layer is also referred to as “Layer 1” herein. Layer 1 is the first layer generated by performing step 304 using the Equ. 1 (described with further detail below).

Layer 1 is computed in accordance with:

Layer 1=OP1(G1)+OP2(T1), (Equ. 1)

where the function OP1(arg) renders an uncolored, untextured geometry specified in the arg, (where G1 is a model of the earth); and OP2(arg) textures the last defined geometry using a texture specified in the arg, (where T1 is an image of the earth viewed from space). OP2(T1) applies texels from image T1 to the uncolored geometry OP1(G1).

Although the exemplary combination of rendered image 500 and textured image 600 serve to produce textured rendition 700 which serves as Layer 1 of the invention, this is for illustrative purposes only. A person skilled in the art appreciates that Layer 1 may be any geographical area and that the geographical area is not limited to the size of the earth. For example, Layer 1 may be a country, a state, a county, a city, a township, and so on.

In order to provide a more detailed image than that provided by rendered textured image 700, the geographical region or region of interest can be made smaller than that encompassed by the rendered textured image 700. The method 300 provides optional steps 306 and 308 for the purpose of providing a more detailed view when desired. As such, neither of these respective steps is necessary to practice the invention and is explained for illustrative purposes only.

At optional step 306, the method 300 renders a geo-polygon of a geographical region smaller than the previously rendered geographical region G1 500. A geo-polygon is a three-dimensional patch of the earth's surface, defined as a set of vertices which have latitude, longitude, and a constant altitude. The geo-polygon consists of an arbitrary shaped triangulated surface conforming to the curvature of the earth at some altitude with one or more textures applied over its extents. The opacity, altitude, applied textures, and shape of geo-polygons can be dynamically altered. Any standard that provides latitude, longitude, and altitude may be used in accordance with the invention, e.g., the WGS-84 or KKJ standard model of the earth.

For example, optional step 306 renders a geo-polygon of a country G2 800 as shown in FIG. 8 (referred to with greater detail below). The rendering process occurs similarly to the rendering described above with respect to G1 and for brevity will not be repeated. In addition, method 300 obtains a texture T2 that can be applied to the geometric model of the country G2.

At step 306, a texture T2 is mapped to the rendered image G2 and forms what is referred to hereafter as a “Layer 2” image. Layer 2 is the second layer generated by performing step 306 using Equ. 2 (described with further detail below).

FIG. 8 depicts the Layer 2 image 800 and a portion of the Layer 1 image 700. FIG. 8 depicts the Layer 2 image 800 as already rendered and textured in accordance with step 306. Layer 1 700 serves as a background with respect to Layer 2 800. For simplicity, Layer 1 700 is depicted as the darkened area outside of Layer 2 800. At step 306 the method renders and textures a map of the sub-region in accordance with:

Layer 2=OP1(G2)+OP2(T2) (Equ. 2)

where the function OP1(arg) renders an uncolored, untextured geometry specified in the arg, (where G2 is a geo-polygon of a country corresponding to T2); and OP2(arg) textures the last defined geometry using texture specified in the arg, (where T2 is an image of the country, e.g., a medium resolution map of the country). OP2(T2) applies texels to the uncolored geo-polygon OP1 (G2). The map T2 depicts a greater degree of detail than the image depicted in step 304. For example, the map T2 depicts items such as major cities, highways, and state roads.

At optional step 308, the method 300 renders a geo-polygon of a geographical region smaller than the previously rendered geographical region G2 800. For example, optional step 308 renders a geo-polygon of a city G3 900 as shown in FIG. 9 (referred to with greater detail below). The rendering process occurs similarly to the rendering described above with respect to G1 and G2 and for brevity will not be repeated. In addition, step 308 applies a texture T3 (as similarly described above with respect to T1 and T2) of the area rendered by the geo-polygon of the city G3.

The textured image T3 900 is an image having a higher resolution than the images T1 and T2. For example, T3 can be a high resolution local map depicting buildings, roads, and other points of interest.

At step 308, the texture T3 is mapped to the rendered image G3 and forms what is referred to hereafter as a “Layer 3” image. Layer 3 is optional and is a third layer generated by performing step 308 using the Equ. 3 (described with further detail below).

FIG. 9 depicts the Layer 3 image 900 and a background layer 902. The background layer is a combination of Layer 1 and Layer 2, and is the background with respect to Layer 3.

The Layer 3 image is acquired by rendering and texturing in accordance with the following:

Layer 3=OP1(G3)+OP2(T3) (Equ. 3)

where the function OP1(arg) renders an uncolored, untextured geometry specified in the arg. (where G3 is a geo-polygon of a city corresponding to T3), and OP2(arg) textures the last defined geometry using texture specified in the arg, (where T3 is a very high resolution image of the city, e.g., an aerial, satellite, or other sensor image). OP2(T3) applies texels to the uncolored geo-polygon OP1(G3).

Steps 304, 306, and 308 are preprocessing steps used to generate one or more geo-polygon of respective textured regions (textured regions of interest). As indicated above, steps 306 and 308 are optional steps that can be applied depending upon the level of resolution desired by a user and/or the availability of these texture images. Although several layers of textured regions of interest are disclosed above, the present invention is not so limited. Specifically, any number of preprocessing steps 304, 306, and 308 of the present invention can be implemented.

At step 310, a user begins the actual selection of an arbitrary defined region for conversion into a 3D geo-polygon from the 2D user selected area. The user may use any type of device (e.g., a mouse, joystick, keypad, touchscreen, or wand) for selecting (a.k.a. “painting”) the desired viewing area. Generally, a 3D geo-polygon is created calculating every point on the 2D outline into the ellipsoidal representation of the earth. This is accomplished by extending a ray from every point on the 2D outline into the ellipsoidal earth, and finding the latitude and longitude of the point of intersection of the ray with the surface of the ellipsoidal earth. Thus, a set of latitudes and longitudes is computed from the 2D outline. This defines the vertices of a 3D geo-polygon which is saved in arg. Alternately, a brush footprint, which may be of arbitrary shape, may be intersected with the ellipsoidal earth. This generates a set of latitudes and longitudes per brush intersection, which are again used as vertices of a 3D geo-polygon. The selection of the arbitrary defined region is defined in accordance with:

OP5(G4(i)) (Equ. 4)

where OP5 computes a 3D geo-polygon from a 2D outline drawn on the screen; and G4 [symbol] represents a set of geo-polygons and the combination of these geo-polygons defines an arbitrary shaped textures. G4(i) also represents the immediate selected position (illustratively by the user input device, e.g., a mouse or joystick) for association with a set of geo-polygons that are used to determine the arbitrary defined region. As such, G4(i) is indicative of an arbitrary shaped region or geo-polygon for association with the arbitrary defined region.

At step 312, other pixels/regions are selected for association with the already existing arbitrary shaped region(s)/geo-polygon(s) within the arbitrarily shaped region. The addition of other arbitrary shaped pixel(s)/region(s) is performed in accordance with:

Add G4(i) to G4 (Equ. 5)

where G4(i) represents a currently selected pixel or region for addition to the set of geo-polygons G4 which define the arbitrary shaped region.

At step 314, the method 300 highlights the selected area by defining the arbitrary shape of the region and storing the entire image (both the arbitrary shape and the background) as a binary mask. Ones are indicative of the presence of the arbitrary shaped region and zeroes are indicative of the background (i.e., the image outside of the arbitrary shaped region).

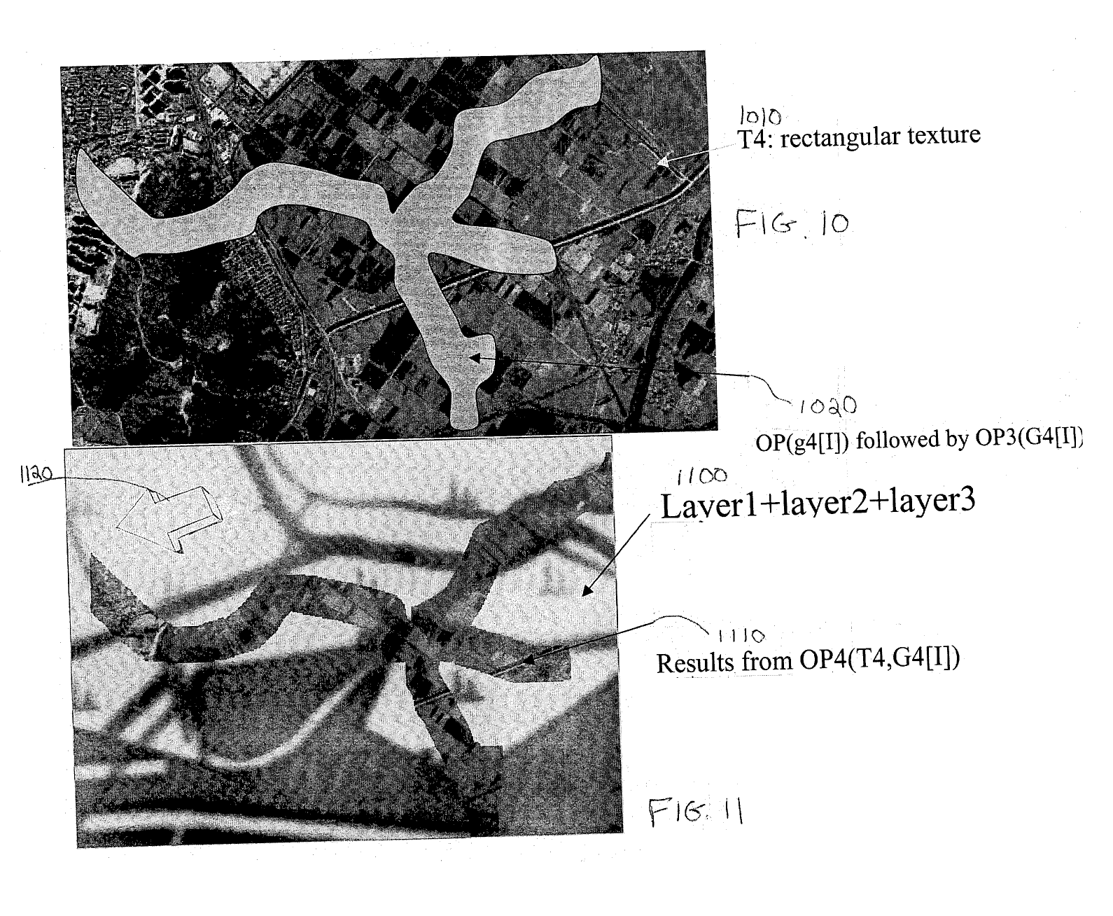

In accordance with steps 312 and 314, FIG. 10 depicts an outline of an arbitrary defined region 1020 selected within a desired geographical area. Illustratively, FIG. 10 depicts the desired geographical area as a very high resolution image T4 1010. Method 300 performs step 314 in accordance with:

OP3(G4(i)) (Equ. 6)

where the function OP3(arg) draws the geometry in offscreen-mode and saves the resulting image as a binary mask with ones and zeros. Ones indicate where geometry was present and zeroes indicate background where no geometry was drawn. G4(i) is each respective geo-polygon for association with the arbitrary defined region.

At step 316, the method 300 applies texels up to and including where the last OP3(arg) function is performed, i.e., where there is the masked arbitrary shaped region defined by Equ. 6. Specifically, step 316 fills in texels within the masked region resulting in a higher resolution image (e.g., a satellite image or aerial photo) within the masked region (the arbitrary defined region) than the resolution of the image outside of the arbitrary defined region. Step 316 is performed in accordance with:

OP4(T4, G4(i)) (Equ. 7)

where the OP4(Targ, Garg) function blends the masked drawing of textured geometry. Fills in texels only where the mask resulting from the last OP3(Garg) is one. Subsequently, blending the resulting image with the image generated from the last OP1 or OP2 operation. The final product of this is the texels of Targ blended into pre-rendered geometry only where Garg geometry would have been rendered.

Illustratively, FIG. 11 depicts a “blended textured image” resulting from Equ. 7 having a textured background image with an arbitrary shape image. Specifically, FIG. 11 shows the acquisition of an image 1110 within the arbitrary defined region where the image 1110 has a higher resolution image than the background layer 1100. The background layer 1110 comprises a number of layers dependent upon the desired viewing area. Illustratively, the background layer 1110 comprises Layer 1, Layer 2, and Layer 3, as explained above.

At step 318, the method queries whether there are other points for selection into the arbitrary shaped region. If answered affirmatively, the method 300 proceeds, along path 320, to step 310 for the insertion of more geo-polygons into the arbitrary shaped region. If answered negatively, the method 300 ends at step 322.

The above method 300 describes an illustrative embodiment of a method of selecting an arbitrary defined region in accordance with the invention. This method may also be referred to as a “painting” method.

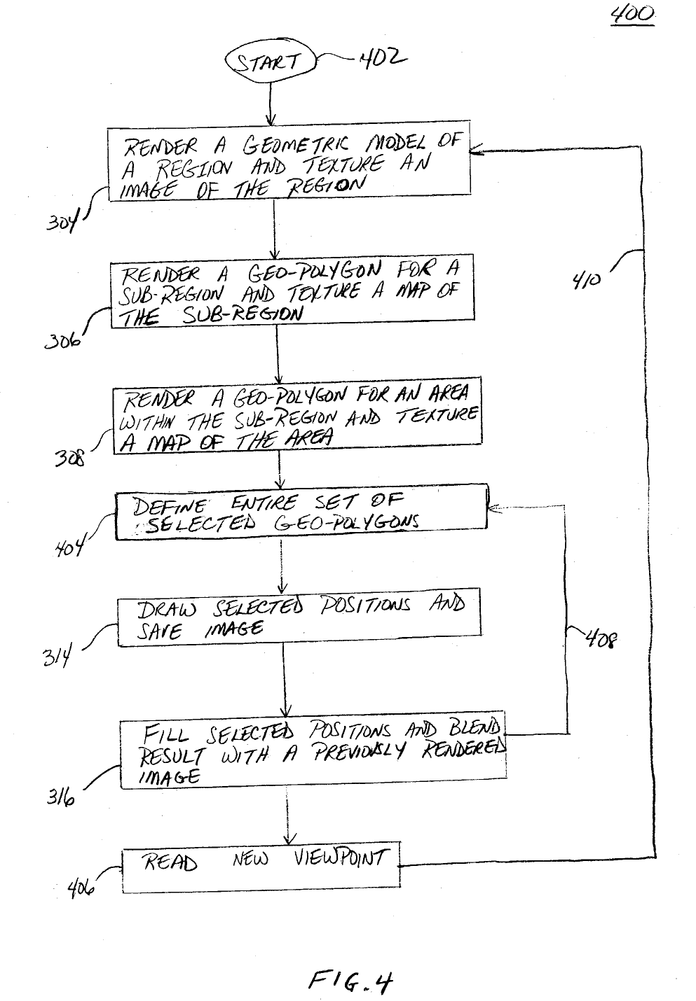

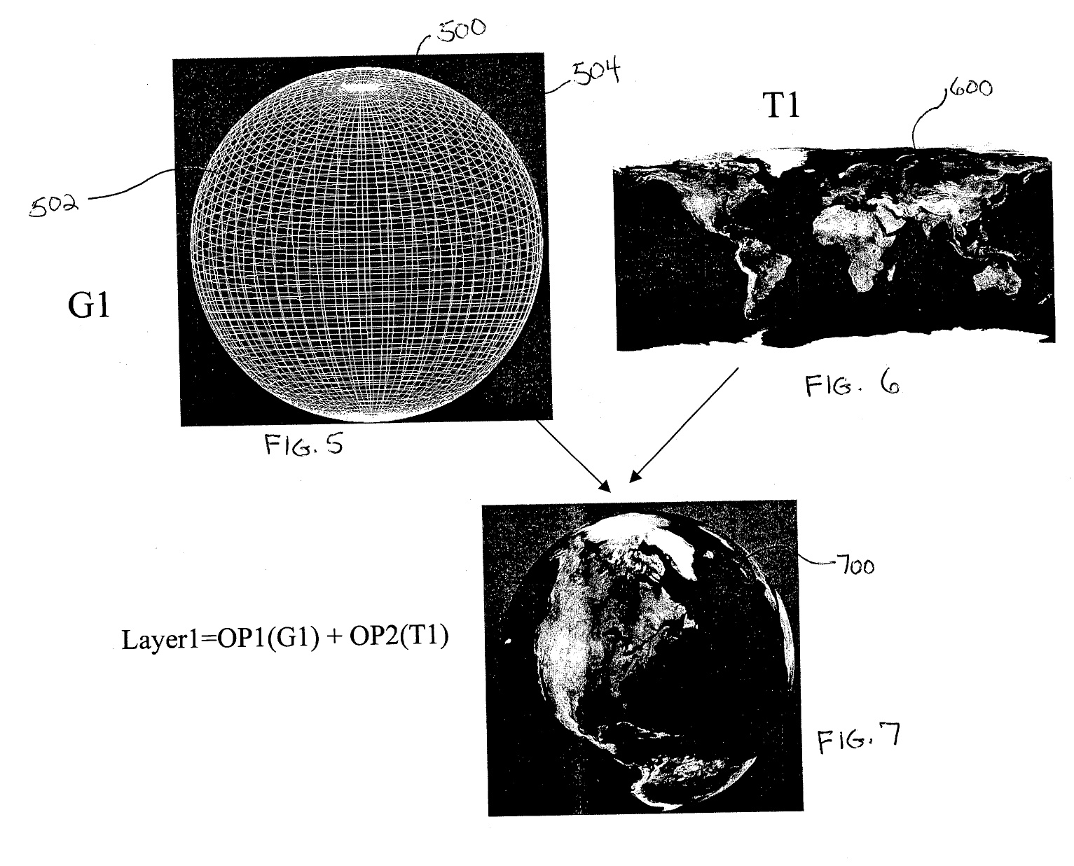

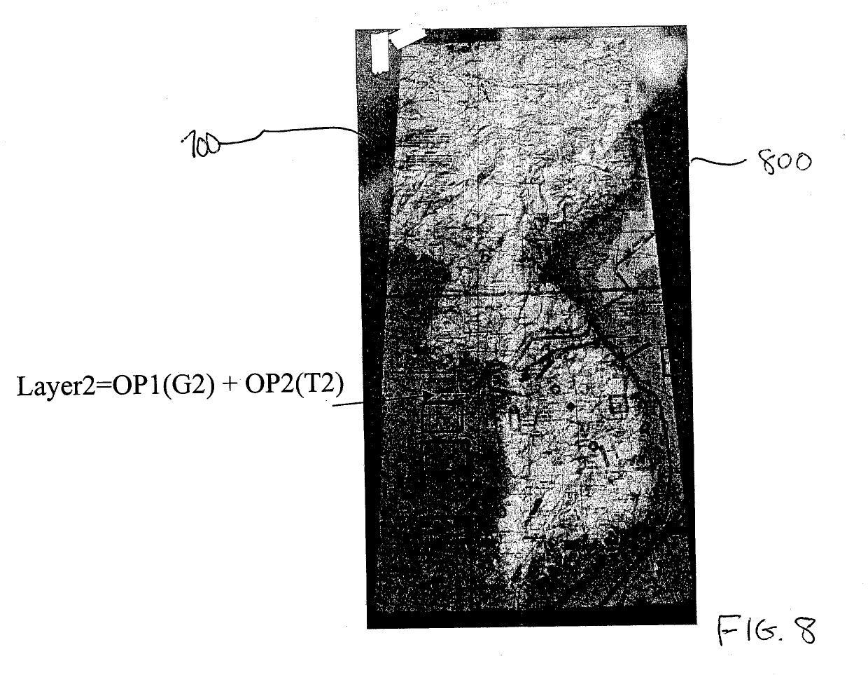

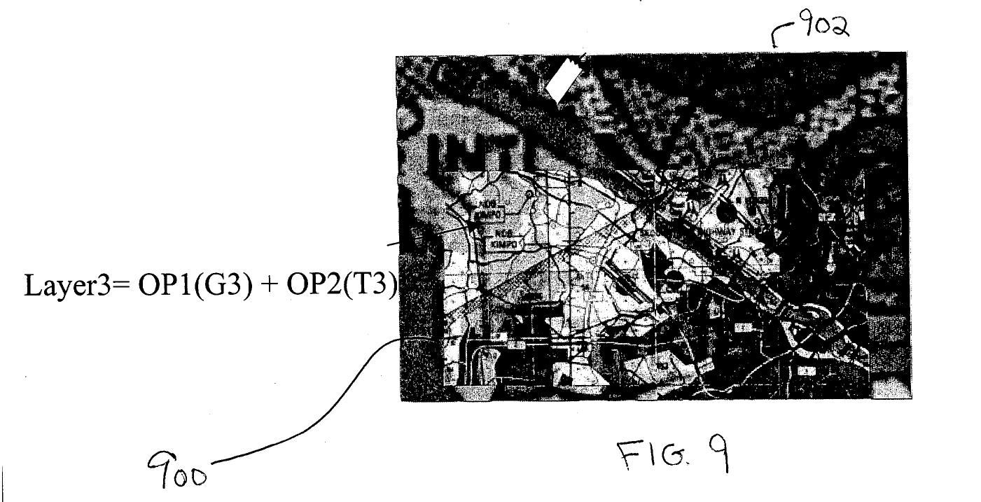

FIG. 4 depicts another illustrative method of the invention. Specifically, FIG. 4 depicts an interactive viewing method 400. In one embodiment, the interactive viewing method 400 can utilize the information from method 300 (i.e., the 3D arbitrary defined region acquired from method 300). For example, after the method 300 has obtained a 3D arbitrary defined region, the interactive method 400 can change the perspective viewing angle of the arbitrary defined region.

Method 400 contains steps similar to steps described with respect to method 300. As such, reference will be made to a described step of method 300 when explaining a corresponding step in method 400.

Again, referring to FIG. 4, method 400 allows a user to alter the perspective view of the previously painted arbitrary shaped area. As already explained, the interactive viewing method 400 is preceded by the interactive painting method 300. In other words, method 400 occurs after the “ending” step 322 of method 300.

The method 400 begins at step 402 and proceeds to step 304. The operation of the functions performed in steps 304, 306, and 308 have already been explained with respect to method 300 of FIG. 3 and for brevity will not be repeated. Steps 304, 306, 308 serve to define a background layer with respect to the arbitrary defined region. As explained with respect to method 300, steps 306 and 308 are optional steps which are implemented when there is a desire to view a smaller geographical region than originally obtained. As such, interactive viewing method 400 may contain more or less steps “layer creating steps” than steps 304, 306, and 308.

After proceeding through step 304 and optional steps 306, and 308, the method 400 proceeds to step 404. At step 404, the method 400 defines a 3D area as the entire set of pixel(s)/region(s) within an arbitrary defined region (e.g., the arbitrary region ascertained from method 300). Method 400 defines the 3D area within an iterative loop:

where i=1 to length(G4 [symbol] ) (Equ. 8)

where i represents an initial pixel/region within the arbitrary defined region and the function length(G4 [symbol] ) represents the textured set of geo-polygons within the arbitrary defined region.

At step 314, method 400 draws the arbitrary defined region and stores the entire image (both the arbitrary shape and the background) as a binary mask, as similarly described with respect to Equ. 6.

The method 400 proceeds to step 316 where method 400 fills the arbitrary defined region with texels and blends the result with a previously rendered image (i.e., a background image, e.g., Layer 1, Layer 2, and Layer 3) as explained above with respect to Equ. 7. However, step 316 as applied in method 400 allows viewing of the arbitrary defined region from the perspective of the pixel/region selected in step 314 of method 400. FIG. 11 depicts a perspective view of an arbitrary defined image 1110 blended with the previously rendered background image 1100 (i.e., Layer 1, Layer 2, and Layer 3).

Thereafter, the method 400 proceeds along path 408 and forms an iterative loop including steps 404, 314, and 316 whereby each of the geo-polygons within the arbitrary defined region is available for selection of pixel/region within the arbitrary defined region.

The method proceeds to step 406, where a user can optionally select (e.g., using a pointing device) another perspective view within the arbitrary shape, e.g., “bird's eye view” or eye level. However, to achieve that it requires a shift in the viewing angle of the geo-polygons. As such, method 400 proceeds along path optional path 410 towards step 304, where method 400 renders the background layer (i.e., Layer 1) for re-computation of the geo-polygons within the arbitrary defined region. Thereafter the method 400 proceed as discussed above.

Although the invention has been described with respect to the association of maps, satellite images, and photos with a geographical location, the above description is not intended in any way to limit the scope of the invention. Namely, an arbitrarily created marker or indicator 1120 can be selectively placed on the blended textured image.

For example, an indicator 1120 (e.g., an arrow) may be associated with a geographical location. As a user changes the perspective of the image, the perspective of the arrow changes accordingly. For example, an arrow may be associated with an image to point towards a building. If the desired perspective is behind the arrow then the user will view the tail end of the arrow. If a different perspective is desired then (e.g., a “bird eye view”) a user has a perspective looking down upon the arrow.

While the foregoing is directed to illustrative embodiments of the invention, other and further embodiments of the invention may be discussed without departing from the basic scope thereof, and the scope thereof is determined by the claims that follow.

What is claimed is:

1. Method for displaying a geo-spatial image, said method comprising the steps of:
a) providing a textured region of interest having a first texture;
b) selecting an arbitrary shaped area within said textured region of interest; and
c) overlaying a second texture over the arbitrary shaped area.

2. The method of claim 1, wherein said step a) comprises the steps of:
a1) rendering a first geometric model of said region of interest;
a2) acquiring said first texture that correlates to said region of interest; and
a3) mapping said first texture over said rendered geometric model.

3. The method of claim 2, wherein said step a) further comprises the steps of:
a4) rendering at least one other geometric model of a subsequent region, wherein said subsequent region is smaller than said region of interest;
a5) acquiring a third texture that correlates to said subsequent region; and
a6) mapping said third texture over said rendered subsequent region and blending said third texture with said underlying first texture.

4. The method of claim 1, wherein said selecting step b) comprises the step of:
b1) generating a binary mask.

5. The method of claim 4, wherein said selecting step b) further comprises the step of:
b2) assigning a common mask value to a pixel or region within said arbitrary shaped region.

6. The method of claim 1, wherein said overlaying step c) comprises the step of:
filling said arbitrary shaped region with said second texture that is different from said first texture of said textured region of interest.

7. The method of claim 6, wherein said second texture is of a higher resolution than a resolution of said first texture.

8. The method of claim 7, wherein said second texture is a photograph.

9. The method of claim 1, wherein said arbitrary shaped area is projected into a 3-dimensional representation.

10. The method of claim 9, further comprising the step of:
d) selecting a different perspective view of said arbitrary shaped region.

11. The method of claim 1, further comprising the step of:
d) providing an indicator within said textured region of interest.

12. The method of claim 11, wherein said indicator is projected into a 3-dimensional representation.

13. A computer-readable medium having stored thereon a plurality of instructions, the plurality of instructions including instructions which, when executed by a processor, cause the processor to perform the steps comprising of:
a) providing a textured region of interest having a first texture;
b) selecting an arbitrary shaped area within said textured region of interest; and
c) overlaying a second texture over the arbitrary shaped area.

14. The computer-readable medium of claim 13, wherein said step a) comprises the steps of:
a1) rendering a first geometric model of said region of interest;
a2) acquiring said first texture that correlates to said region of interest; and
a3) mapping said first texture over said rendered geometric model.

15. The computer-readable medium of claim 14, wherein said step a) further comprises the steps of:
a4) rendering at least one other geometric model of a subsequent region, wherein said subsequent region is smaller than said region of interest;
a5) acquiring a third texture that correlates to said subsequent region; and
a6) mapping said third texture over said rendered subsequent region and blending said third texture with said underlying first texture.

16. The computer-readable medium of claim 13, wherein said selecting step b) comprises the step of:
b1) generating a binary mask.

17. The computer-readable medium of claim 16, wherein said selecting step b) further comprises the step of:
b2) assigning a common mask value to a pixel or region within said arbitrary shaped region.

18. The computer-readable medium of claim 13, wherein said overlaying step c) comprises the step of:
filling said arbitrary shaped region with said second texture that is different from said first texture of said textured region of interest.

19. The computer-readable medium of claim 18, wherein said second texture is of a higher resolution than a resolution of said first texture.

20. The computer-readable medium of claim 19, wherein said second texture is a photograph.

21. The computer-readable medium of claim 13, wherein said arbitrary shaped area is projected into a 3-dimensional representation.

22. The computer-readable medium of claim 21, further comprising the step of:
d) selecting a different perspective view of said arbitrary shaped region.

23. The computer-readable medium of claim 13, further comprising the step of:
d) providing an indicator within said textured region of interest.

24. The computer-readable medium of claim 23, wherein said indicator is projected into a 3-dimensional representation.

25. Apparatus for displaying a geo-spatial image, said apparatus comprising:
means for providing a textured region of interest having a first texture;
means for selecting an arbitrary shaped area within said textured region of interest; and
means for overlaying a second texture over the arbitrary shaped area.

26. The apparatus of claim 25, wherein said means for providing a textured region of interest renders a first geometric model of said region of interest, acquires said first texture that correlates to said region of interest and then maps said first texture over said rendered geometric model.

27. The apparatus of claim 26, wherein said wherein said means for providing a textured region of interest further renders at least one other geometric model of a subsequent region, wherein said subsequent region is smaller than said region of interest, acquires a third texture that correlates to said subsequent region, and maps said third texture over said rendered subsequent region and blending said third texture with said underlying first texture.

28. The apparatus of claim 25, wherein said means for selecting an arbitrary shaped area generates a binary mask.

29. The apparatus of claim 28, wherein said means for selecting an arbitrary shaped area further assigns a common mask value to a pixel or region within said arbitrary shaped region.

30. The apparatus of claim 25, wherein said means for overlaying fills said arbitrary shaped region with said second texture that is different from said first texture of said textured region of interest.

31. The apparatus of claim 30, wherein said second texture is of a higher resolution than a resolution of said first texture.

32. The apparatus of claim 31, wherein said second texture is a photograph.

33. The apparatus of claim 25, wherein said arbitrary shaped area is projected into a 3-dimensional representation.

34. The apparatus of claim 33, further comprising:
means for selecting a different perspective view of said arbitrary shaped region.

35. The apparatus of claim 25, further comprising:
means for providing an indicator within said textured region of interest.

36. The apparatus of claim 35, wherein said indicator is projected into a 3-dimensional representation.
